(19) United States
(12) Patent Application Publication
(10) Pub. No.: US 2019/0211975 A1
(43) Pub. Date: Jul. 11, 2019

(54) BULBS WITH INDIRECT ILLUMINATION

(71) Applicant: ANNA RUBIN-BRUSILOVSKI, San Diego, CA (US)

(72) Inventor: ANNA RUBIN-BRUSILOVSKI, San Diego, CA (US)

(21) Appl. No.: 15/865,974

(22) Filed: Jan. 9, 2018

(51) Int. Cl. F21K 9/237; F21K 9/238; F21K 9/68; F21K 9/64; F21K 9/232; F21V 7/00; F21V 7/04; F21V 13/02

(52) U.S. Cl. CPC F21K 9/237; F21K 9/238; F21K 9/68; F21K 9/64; F21Y 2115/10; F21V 7/0008; F21V 7/041; F21V 13/02; F21K 9/232

(57) ABSTRACT

Light bulbs based on laser diodes and light-emitting diodes, using indirect illumination with white or variable color are described; narrow directed beams of laser diodes and beams of light-emitting diodes are reflected from a curved mirror located in the center of the lamp, which has a diffuse or a multi-faceted surface or a luminophore covered surface; reflected from such mirrors, light beams are mixed and converted to a homogeneous light, uniformly distributed in space.

### TECHNICAL FIELD

In general, the present invention pertains to the art of electricity and optics. In particular, the invention relates to lamps used for illumination of buildings, halls, rooms, streets, etc.

### BACKGROUND ART

There are several lamps known in the art using Light Emitting Diodes (LEDs), for example, U.S. Pat. Nos. 7,654,699 and 9,299,687.

For a better spatial dissipation of the light beams emitted by LEDs and for the elimination of glare, many low power LEDs, matt bulbs and covers are used in such lamps and luminaires. Low-power LEDs make the lamp more complex and expensive, because the one lamp module must be constructed from many LEDs. The matt bulbs and covers that are used absorb up to 40% of light and thus reducing the efficiency of the lamps.

In addition, due to the large number of low-power LEDs in the lamps, bulbs of 100 Watt and more have large, non-standard dimensions.

Parabolic and ellipsoidal mirrors are used in ceiling lights, spotlights and LED floodlights. They may have smooth, diffuse or multi-faceted surface. In such devices, the light sources are in the center of these mirrors.

Recently the industry has started to produce powerful, bright and cheap light sources (laser diodes and LEDs) with high light output (lumens per watt). For example, Lumileds produce lighting fixtures which use LEDs with efficiency of 150 lm/w. Moreover, laser diodes PLTB450B with 450 nm and 1400 my are available from Osram.

Such LEDs however are used only on posts of street lighting, not inside houses or buildings. Laser diodes are not used for lighting, although they are used for lighting in automobile headlamps. There are no cheap, compact and efficient lamps with such light sources; there are no compact LED bulbs with power more than 100 Watt.

The reasons for this are as follows: (i) bright light from such light sources is difficult to convert into spatially diffused light in the lamps, (ii) it is difficult to eliminate glare, and (iii) laser diodes and powerful LEDs require significant cooling. The placement of such light sources in the center of the bulbs creates additional difficulties due to the need of large amounts of heat diversion.

An existing ceiling indirect lighting luminaire disclosed in CN203549466, U.S. Pat. Nos. 8,596,807, 8,573,802 and US20140268715 A1 use LEDs and diffuse mirrors with indirect illumination.

However, it is a lighting luminaire, not a lamp, that is why it has no size limits. In addition, multi-faceted mirror surface and ordinary luminophore coated mirrors are not used in such lighting.

### DESCRIPTION OF THE DRAWINGS

The present invention will be understood and appreciated more comprehensively from the following detailed description taken in conjunction with the appended drawings in which:

FIG. 1 is a cross-sectional view of an illumination device with the use of laser diodes;

FIG. 2 is an enlarged cross-sectional view of the path of a non-collimated laser beam emitted by a laser diode and a light spot on a conical diffuse mirror surface;

FIG. 3 is a scheme of light reflection in the lamp, the light is emitted by a laser diode and reflected from a conical diffuse mirror surface;

FIG. 4 is a schematic isometric view of light spots of non-collimated laser diodes emission and direction of reflected diffused light;

FIG. 5 is a cross-sectional view of the LEDs in the lamp and light spots from LEDs' emission on a conical diffuse mirror surface;

FIG. 6 is a schematic isometric view of light spots of LEDs' emission on a conical diffuse mirror surface;

FIG. 7 is a schematic cross-sectional view of a different form of diffuse mirror surfaces that can be used in lamps;

FIG. 8 is a schematic cross-sectional view of a different form of diffuse mirror surfaces that can be used in lamps;

FIG. 9A is a schematic isometric view of a version of the lamp where the light passes through small holes in diffuse mirrors;

FIG. 9B is a schematic isometric view of another version of the lamp where the light passes through small holes in diffuse mirrors;

FIG. 10 is a top schematic view of several separate diffuse surfaces with dimensions corresponding to the light spots;

FIG. 11 is a scheme of the laser diode light emitted on a conical luminophore covered luminophore mirror surface inside the lamp;

FIG. 12 is a scheme of the light reflection in the lamp, the light emitted from a laser diode to a mirror surface, covered with luminophore;

FIG. 13 is a schematic isometric view of a multi-faceted conical surface of a diffuse mirror;

FIG. 14 is a schematic cross-sectional view of a version of the lamp, with one or several LEDs being in the center of the diffuse surface;

FIG. 15 is a schematic cross-sectional view of a version of the lamp, with an additional cylindrical mirror;

FIG. 16 is a schematic cross-sectional view of a version of the lamp using a reflector;

FIG. 17 is a schematic cross-sectional view of a linear luminaire with indirect illumination;

FIG. 18 is a schematic cross-sectional view of an embodiment with several LEDs in the center of the diffuse surface and in the center of the lamp.

While the invention is susceptible to various modifications and alternative forms, specific embodiments thereof have been shown merely by way of example in the drawings. The drawings are not necessarily complete and components are not essentially to scale; emphasis instead being placed upon clearly illustrating the principles underlying the present invention.

### DETAILED DISCLOSURE OF EMBODIMENTS

Illustrative embodiments of the invention are described below. In the interest of clarity, not all features of actual implementation are described in this specification. It will of course be appreciated that in the development of any such actual embodiment, numerous implementation-specific decisions must be made to achieve the developers' specific goals, such as compliance with technology- or business-related constraints, which may vary from one implementation to another. Moreover, it will be appreciated that the effort of such a development might be complex and time-consuming, but would nevertheless be a routine undertaking for those of ordinary skill in the art having the benefit of this disclosure.

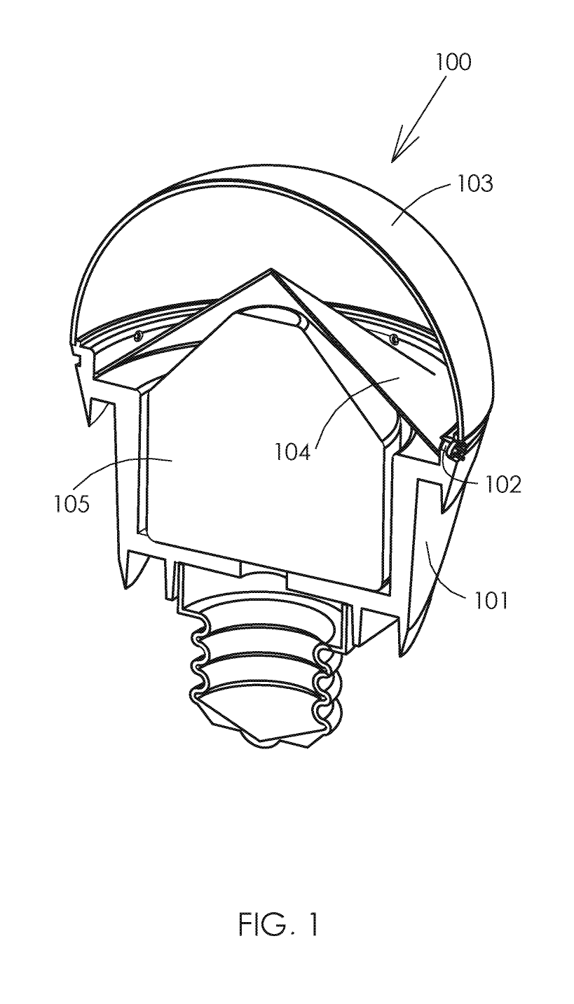

FIG. 1 shows one of the variants of such lamp. Lamp 100 consists of a cooling body 101, in which the laser diodes or LEDs 102 are placed, a bulb 103 and a curved mirror with a diffuse surface 104. In this example, the mirror has a cone shape. The number of laser diodes and LEDs installed in the lamp depends on the power and purpose of the lamp.

The ellipsoidal and parabolic mirrors are used in existing floodlights and spotlights. They may have smooth, diffuse or multi-faceted surface. Light sources in such devices are in the center and the mirror surface covers these light sources from the outside. In the proposed invention, it is vice versa. The mirror is in the center of the lamp, while the light sources are located at the exterior along the perimeter of the lamp.

The driver 105 is located inside the body 101. It can be located not only inside the body 101, but also occupy the space underneath the curved diffusing light mirror 104. It possible since the light inside the lamp spreads between the mirror 104 and the bulb 103.

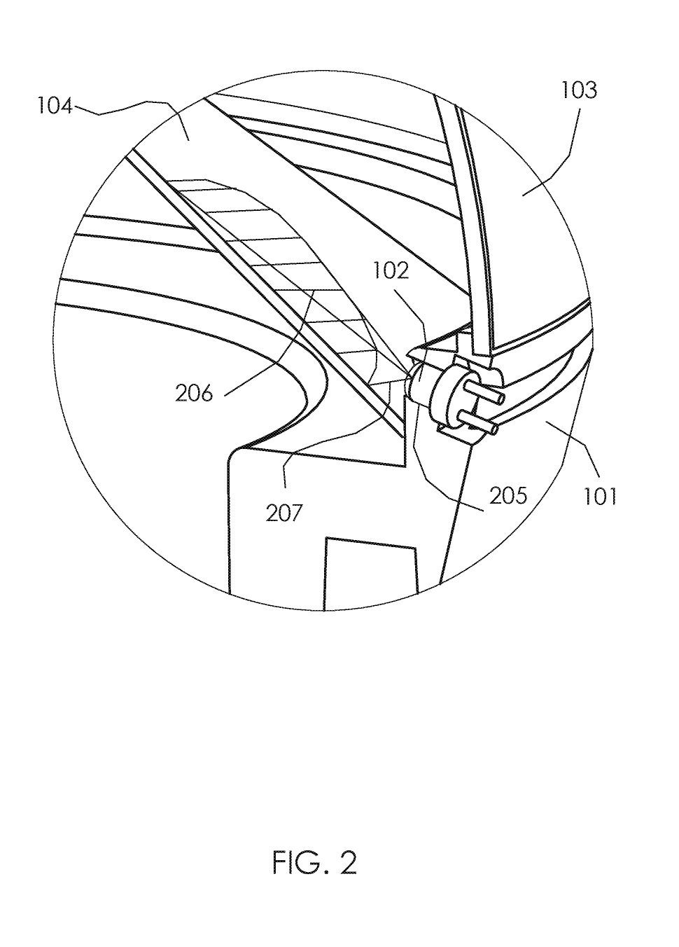

FIG. 2 shows the top part of the lamp without the bulb. In the body 101 there are holes 205 located along the circumference. Laser diodes 102 are inserted into these holes. Non-collimated beams 207 emitted from the laser diodes 102 are directed to the center f the lamp. The beams may be sent perpendicular to the lamp axis or at another angle. The beams 207 are emitted from the laser diodes light spots 206 onto the surface of the light scattering mirror 104. If the bulb 103 is transparent, these light spots 206 are visible to human eye as emission sources. As the area of the light spots 206 is much larger than area of the emitting laser diodes chips, the brightness of the light spots 206 will be much lower than the brightness of the light emitted by the lasers diodes 102. It means that the glare in such lamps will be much smaller; this allows: (1) to use powerful super-bright and economical LEDs and laser diodes in these lamps, while receiving plenty of light without glare, (2) to make a matt bulb much more transparent and thus get greater light output from the lamp and (3) to reduce the lamps size, as they use less light sources.

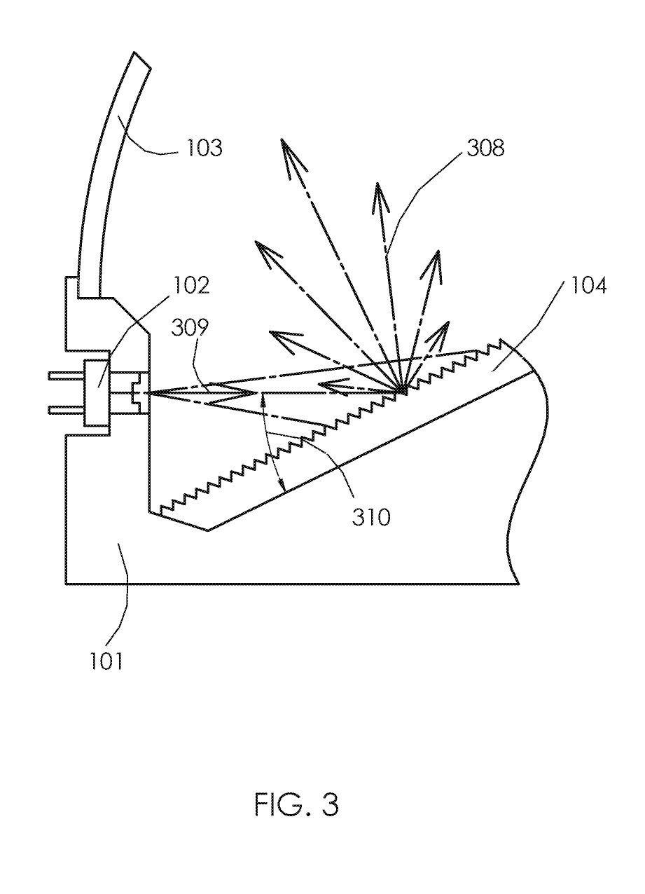

For reflection and uniform diffusion of light in space, referring to FIG. 3, where light scattering mirrors 104 are used in the lamp. They may have a diffuse or multi-faceted surface. To ensure the reflection of the maximum amount of light 308 in the direction of bulb 103, a mirror surface 104 with a close to conic shape is used in the lamp. As the light sources 102 are located on the circumference of the lamp, such mirror form is most suitable for uniform diffusion of light. The maximum of diffuse reflected light 308 is reflected perpendicular to the diffuse mirror surface according Lamberts emission law regardless of the angle 310 between the diffuse mirror surface 104 and incident light 309.

That is why the light 308 reflected from the curved scattering mirror 104 uniformly blends and angular expansion of beams 308 occur so that the inside of the entire emission surface of the bulb is uniformly illuminated 103.

An efficient heat sink is ensured by placing the laser diodes 102, shown in FIG. 2, on the cylindrical surface of the lamp body, outside. Laser diodes heat is removed through contact surface 205.

The laser diodes 102 and the LEDs 511 are arranged in the lamp so that their emitters are not visible, and only the less bright light spots located on the diffuse mirror are visible.

If RGB laser diodes or LEDs are used in the lamp, such lamp may emit white light and be color changeable. Changing the emission power of each laser or each LED allows receiving light with many colors and shades. A bulb 103 in such lamps can be transparent, transparent with fine relief or lightly matted.

If the lasers or the LEDs that are used in the lamp have a wavelength that excites luminophore, such lamp emits white light. The bulb 103 of such lamp must contain luminophore on its surface or inside.

In the lamp, white light can be obtained by using only bright white LEDs; to improve the quality of light (improved CRI), LEDs of other colors may be added, such as lime, blue, etc.

The following TABLE 1 shows options of getting different colors in lamps depending on mixing of different parts: light sources, bulbs and mirror surfaces.

TABLE 1
Combinations of Different Colors

| | Combinations of Different Colors | | | |
|---|---|---|---|---|
| | Emitted | | | Reflective |
| # | Light | Light Source | Bulb Type | Surface |
| 1 | White | Blue laser | Luminophore | Diffused |
| | | diodes | covered | Luminophore |
| | | | Transparent | covered |
| 2 | Color | RGB laser | Transparent, | Diffused |
| | Changeable | diodes | transparent with | |
| | | | fine relief, with | |
| | | | light matt | |
| 3 | White | White super | Transparent, | Diffused |
| | | bright LEDs | transparent with | |
| | | | fine relief, with | |
| | | | light matt | |
| 4 | Color | RGB LEDs | Transparent, | Diffused |
| | Changeable | | transparent with | |
| | | | fine relief, with | |
| | | | light matt | |
| 5 | White | Blue LEDs | Luminophore | Diffused |
| | | | covered | Luminophore |
| | | | Transparent | covered |
| 6 | White with | White LEDs, | Transparent, | Diffused |
| | Shades | RGB LEDs or | transparent with | |
| | | laser diodes | fine relief, with | |
| | | | light matt | |
| 7 | White with | RGB laser, | Transparent, | Diffused |
| | Shades | Diodes with | transparent with | |
| | | RGB LEDs | fine relief, with | |
| | | | light matt | |

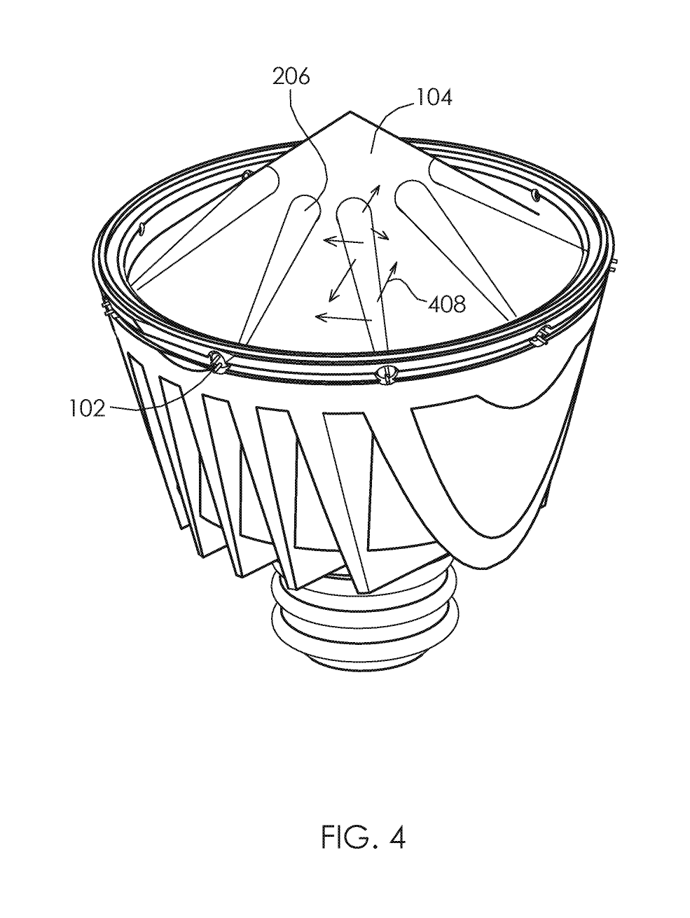

In FIG. 4 the light spots 206 on the scattering mirror 104 and the direction of reflected diffused light emission 408 are visible. These light spots 206 are created by the emission of non-collimated laser diodes 102 (there is no bulb in FIG. 4). After the reflection from the scattering mirror 104, the light beams 408 are not only scattered in space in the direction of the bulb, but are also uniformly mixed. This configuration allows to efficiently use RGB light sources.

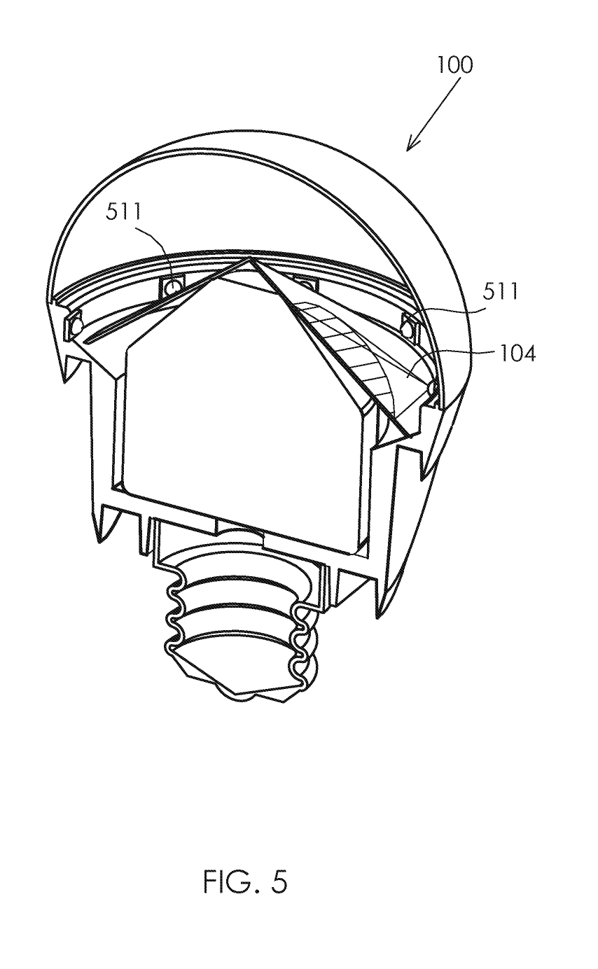

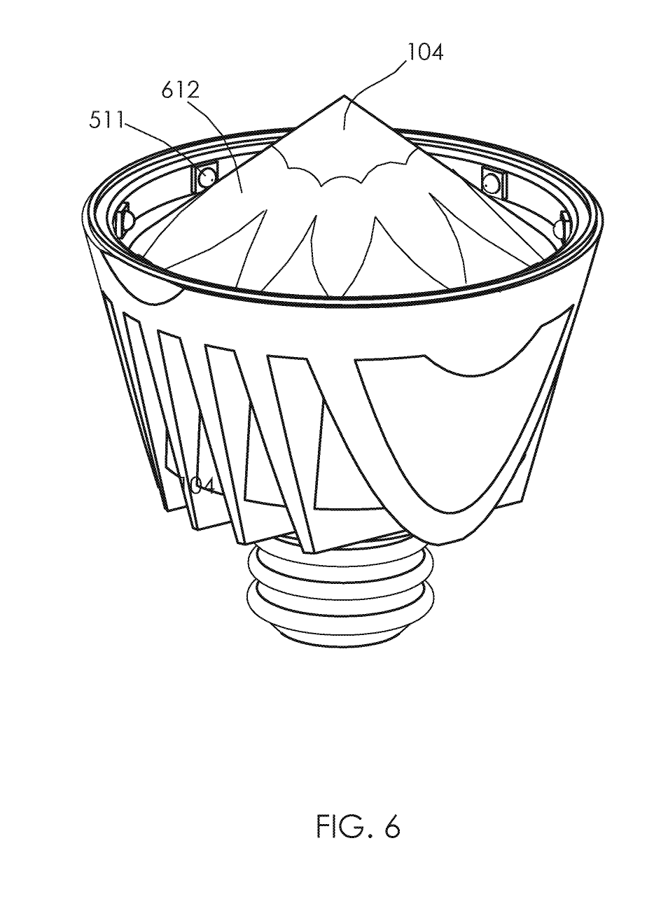

In FIG. 5 a cross-section of another lamp design is shown, with LEDs 511 as the emission sources instead of laser diodes. LEDs create rounder light spots 612, shown in FIG. 6, on the diffuse mirror 104.

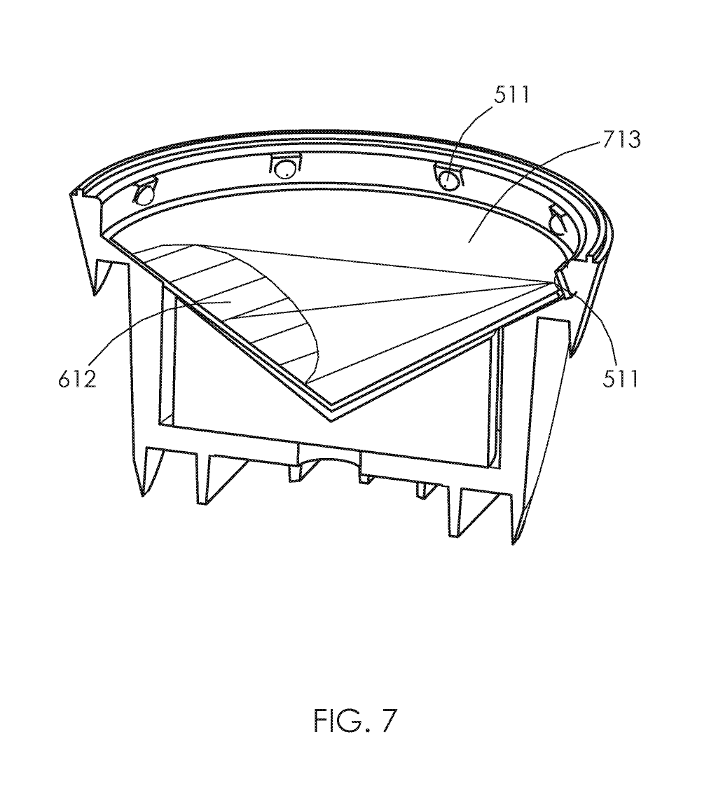

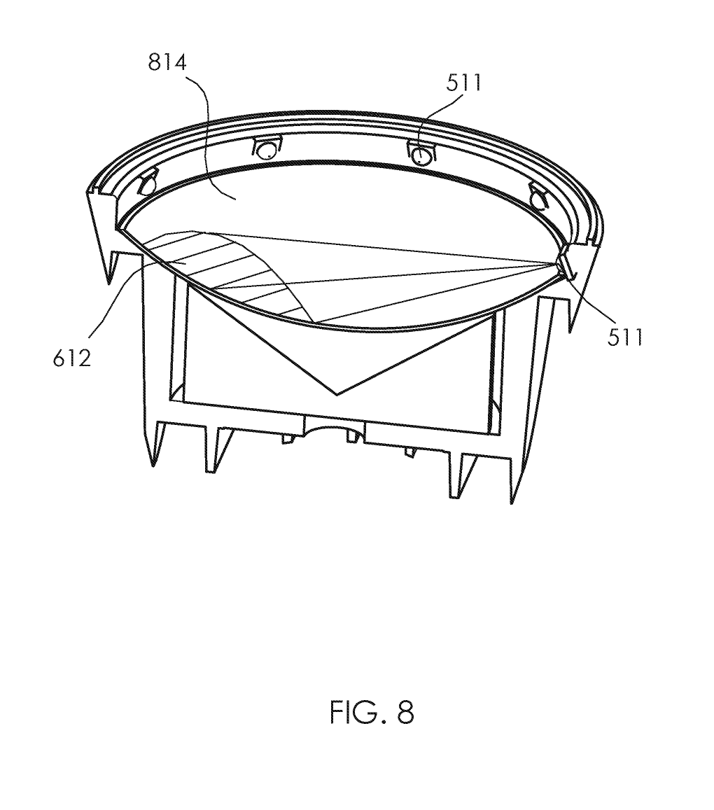

In FIG. 7 and FIG. 8 other lamp designs are shown. In these lamps, the light sources 511 are located at different angles to the lamp axis and in each lamp various forms of scattering mirrors are used. In FIG. 7 a conical mirror with wider side facing upwards 713 is used. In FIG. 8 the surface 814 has a shape close to spherical such as ellipsoidal, parabolic or another similar surface.

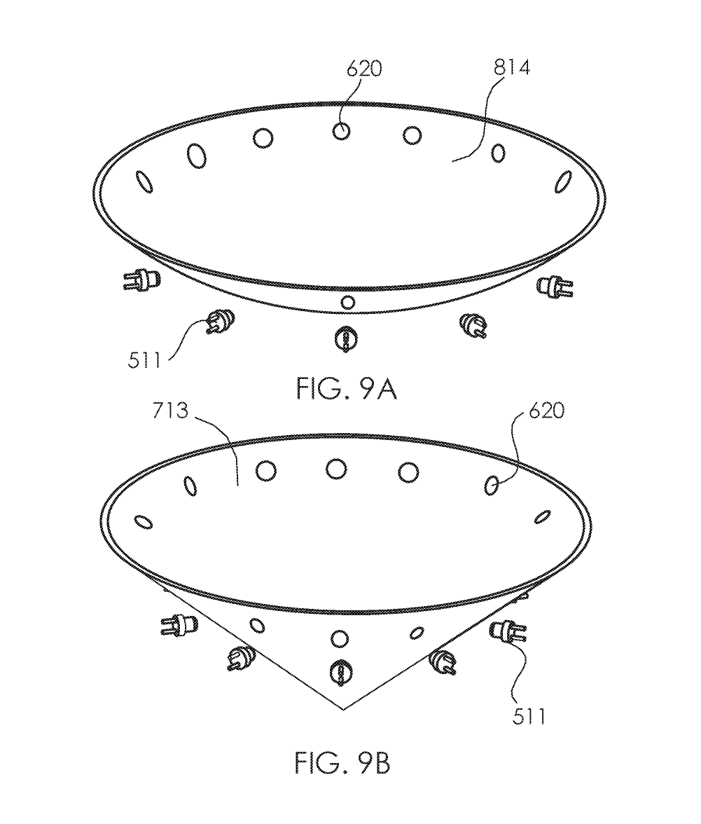

When using such forms of scattering mirrors 814 and 713, shown in FIGS. 9A and 9B, the light sources 511 can be positioned opposite to the scattering mirror and holes 620 can be made in the scattering mirror for light passing.

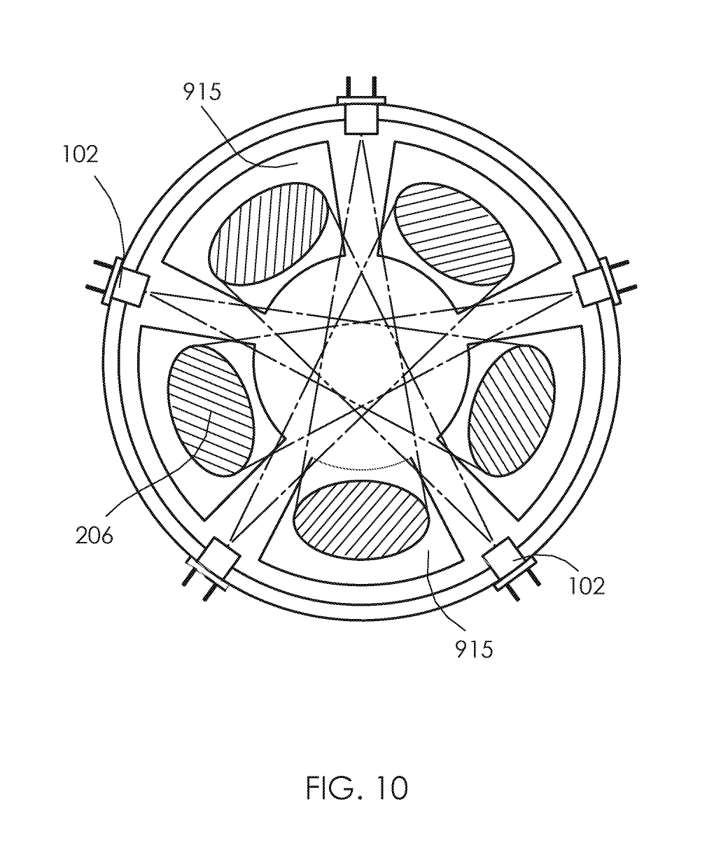

One or multiple individual scattering mirrors of complex form may be used in the lamp. In FIG. 10, as an example, five light sources 102 and five separate scattering mirrors 915 are presented. The sizes of these mirrors must match the sizes of the light spots 206.

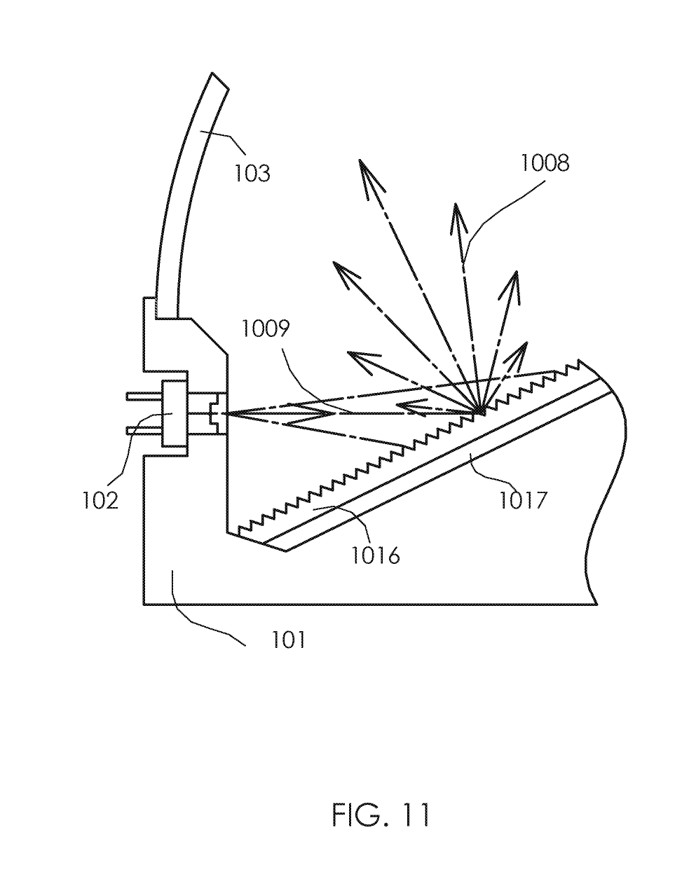

The scheme of white light reflection 1008 is shown in FIG. 11. The blue light beams 1009 emitted by the laser diode 102 are transformed by a conically shaped mirror coated with luminophore 1016. The mirror 1017 is located under the luminophore.

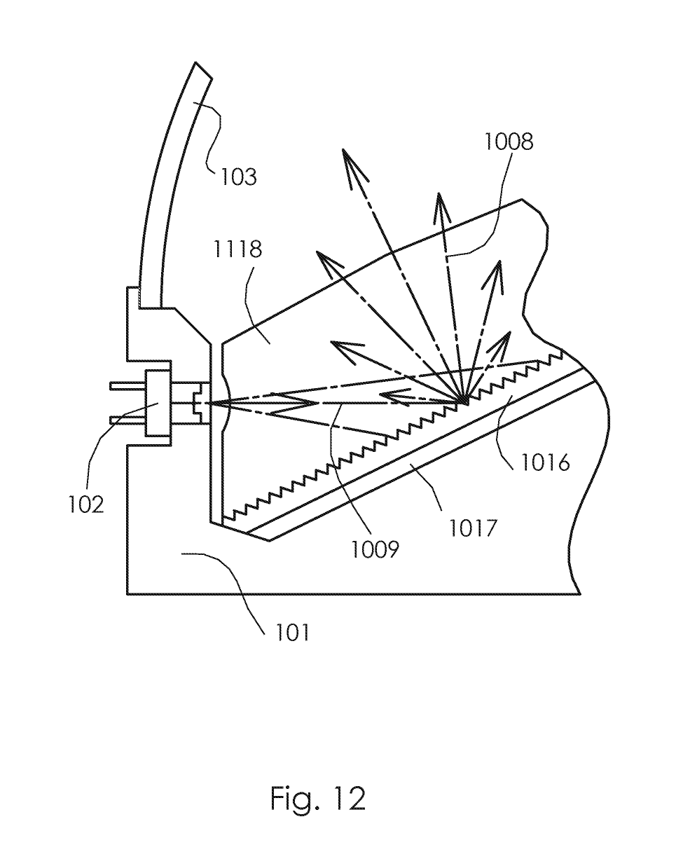

A lamp with a transparent light guide 1118 is presented in FIG. 12. A scattering mirror or luminophore 1016 together with mirror 1017 are located on the back wall of the transparent light guide.

To improve light quality and to increase the power of the lamp, laser diodes 102 and LEDs 511 can be placed in the lamp together.

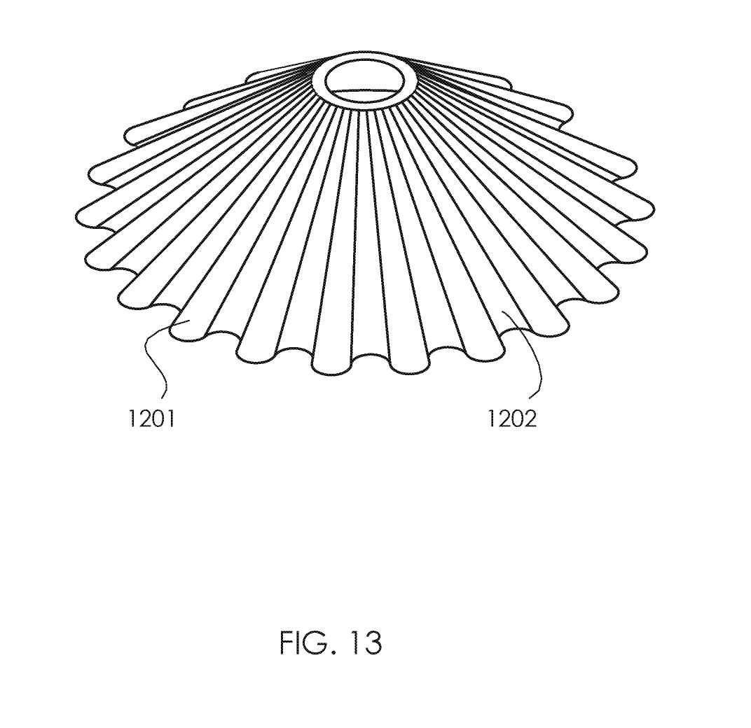

Another version of the scattering mirror surface—a mirror with multi-faceted surface 1201 is shown in FIG. 13. This mirror also has a conical shape. Lower parts of this mirror may be filled by one or several types of luminophore emitting white light. As a result, this white light can have a spectrum with different shades.

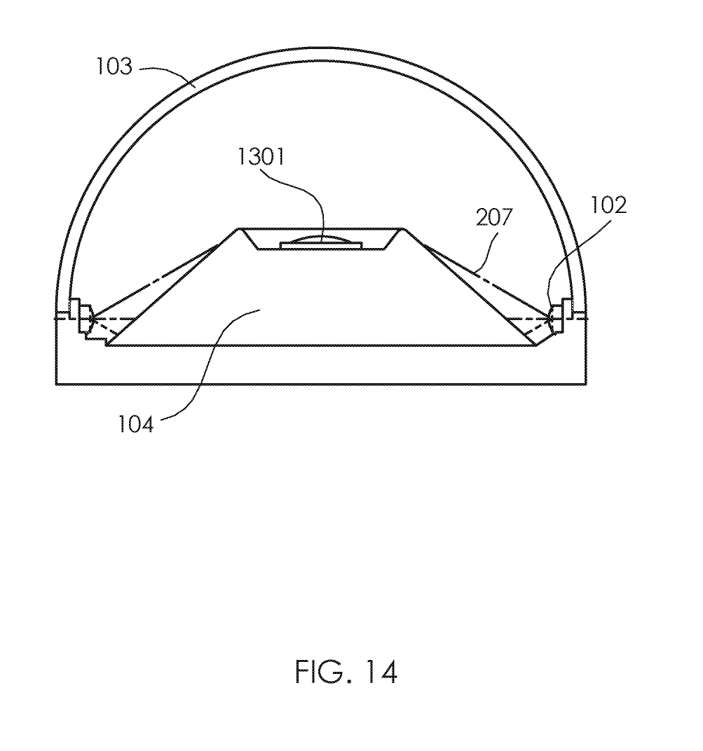

Another design of the lamp in which the LED 1301 is in the center of the light scattering mirror is shown in FIG. 14. Such design allows to get white light with spectrum close to the solar spectrum. If this is a large lamp or luminaire, several LEDs or an LED module may be placed in the center of the mirror.

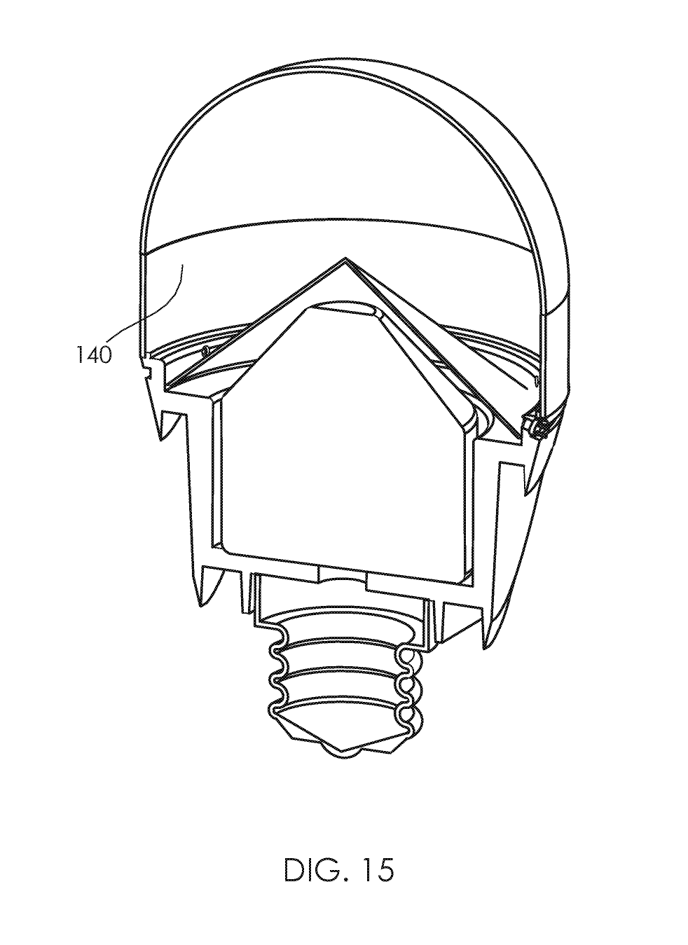

A lamp design with an additional cylindrical mirror 1401 is shown in FIG. 15. In some cased, this allows to improve the light output of the lamp.

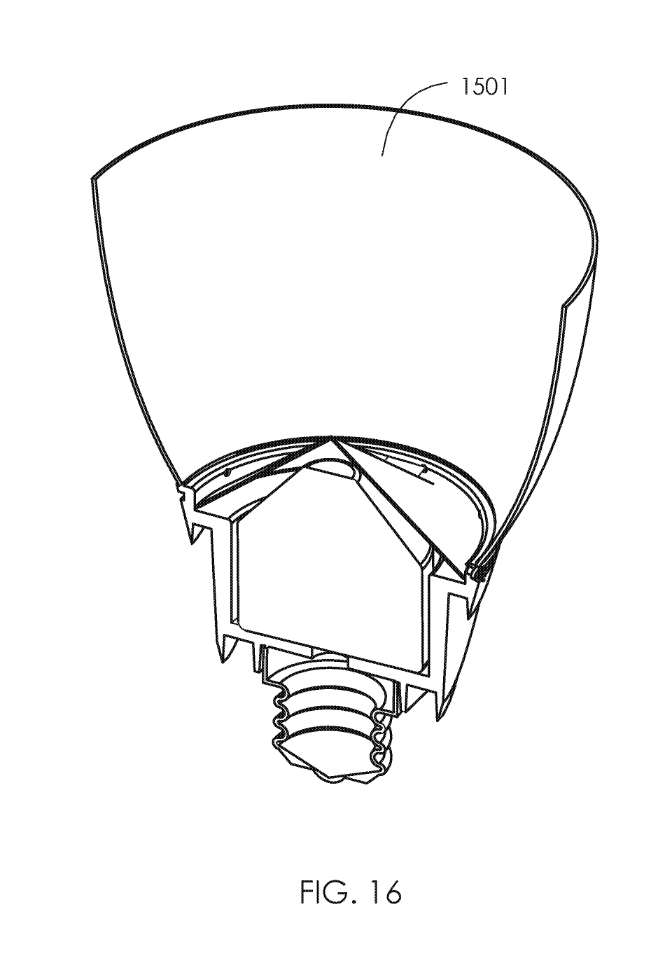

A lamp design with a reflector 1501 instead of a cover is shown in FIG. 16.

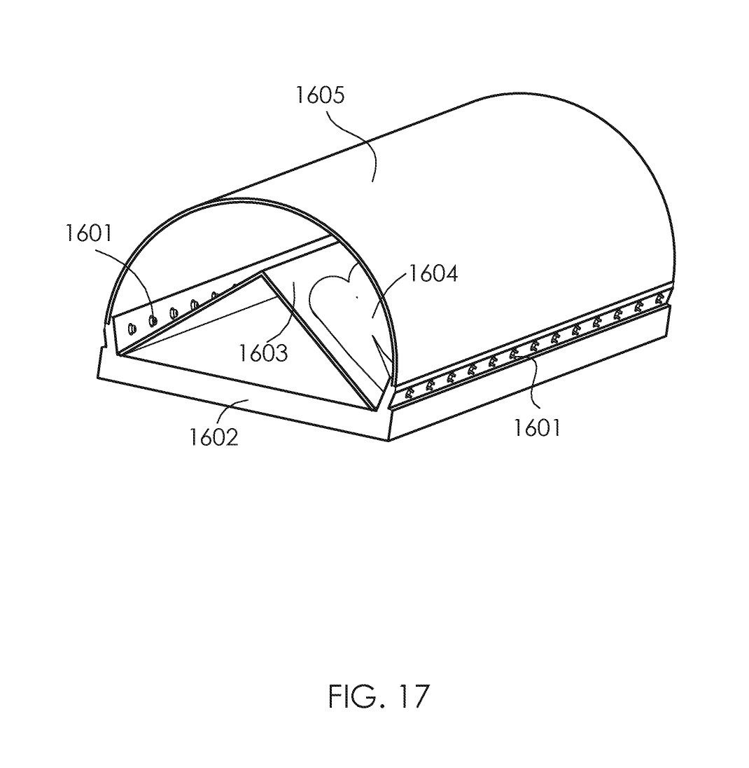

All the lamp designs described above show the lamp body as a surface of revolution. A linear lamp with indirect illumination is shown in FIG. 17. The light sources 1601 are placed in a rectilinear body 1602. The scattering mirror 1603 and transparent cover 1605 also have rectilinear forms. The light spots are also located along the scattering mirror.

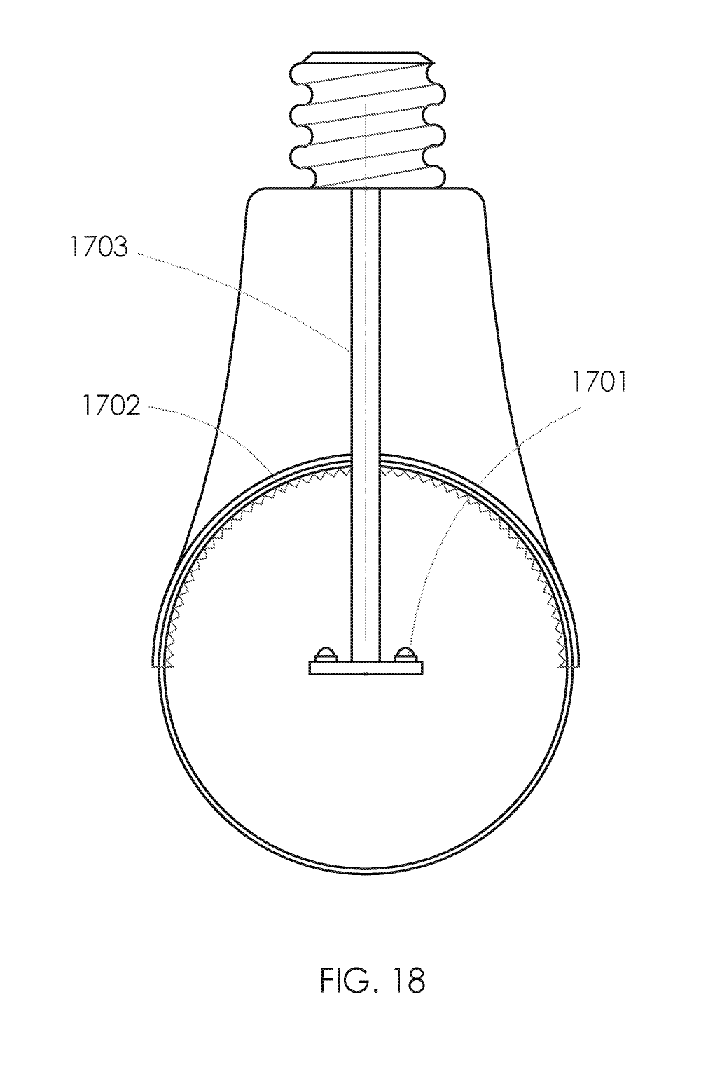

Another embodiment of the lamp in which the LEDs 1701 is in the center of the light scattering mirror 1702 is shown in FIG. 18. Heat is removed through a support 1703. Support 1703 is covered with scattering mirror 1702. The lamp shown in creates scattered light with no glare. This lamp shown in FIG. 18 allows the brightest and most cost-efficient LEDs that are used only for external lightning. That is why the lamp of such a construction is cost-efficient to the maximum and can create a large amount of light. The cover of such a lamp can be transparent or can have a light frosting surface. The use of RGB LEDs makes the lamp change color.

Two working prototypes were built. The first uses blue laser diodes. The second uses blue LEDs.

It will be appreciated by persons skilled in the art that the present invention is not limited by what has been particularly shown and described herein above. Rather the scope of the invention is defined by the claims which follow:

1. An illumination device comprises:
(a) a bulb-shaped housing;
(b) an electric driver, configured to collect and supply a preset electric current;
(c) a plurality of illumination elements selected from the group consisting of: laser diodes, light-emitting diodes and any combination thereof;
(d) at least one light-diffusing reflective surface selected from the group consisting of: a diffused surface, multi-faceted mirror surface and smooth mirror surface covered with luminophore; wherein said at least one light-diffusing reflective surface is located opposite to said plurality of illumination elements;
wherein said plurality of illumination elements are not visible and obstructed by at least one part selected from the group consisting of: said at least one light-diffusing reflective surface and dedicated obstructing element;
wherein light beams emitted by said plurality of illumination elements are reflected from said least one light-diffusing reflective surface and form indirect illumination on an exterior surface of said bulb-shaped housing;
wherein light spots formed on said exterior surface of said bulb-shaped housing do not create glare.

2. The illumination device as in claim 1, wherein light spots formed on said exterior surface of said bulb-shaped housing are form homogeneous and diffused light, uniformly distributed across said exterior surface of said bulb-shaped housing.

3. The illumination device as in claim 1, wherein a white light is formed on said exterior surface of said bulb-shaped housing by reflection of blue beams emitted by said plurality of illumination elements from at least one light-diffusing reflective surface which are then transformed by passing through a luminophore coating on said bulb-shaped housing.

4. The illumination device as in claim 1, wherein a white light is formed on said exterior surface of said bulb-shaped housing by reflection of blue beams emitted by said plurality of illumination elements from at least one light-diffusing reflective surface which are transformed by passing through a luminophore coating on said at least one light-diffusing reflective surface.

5. The illumination device as in claim 1, wherein a color changeable light is formed on said exterior surface of said bulb-shaped housing by of color and white beams emitted by said plurality of illumination elements reflect from a scattering mirror surface which and mix on said at least one light-diffusing reflective surface.

6. The illumination device as in claim 1, wherein said plurality of illumination elements is mounted onto a dedicated carrier element, which is then installed in said bulb-shaped housing.

7. The illumination device as in claim 1, wherein said lamp driver assumes all space inside said bulb-shaped housing under said at least one light-diffusing reflective surface.

8. The illumination device as in claim 1, wherein at least one illumination element is disposed at a center of said at least one light-diffusing reflective surface.

9. The illumination device as in claim 1, wherein said at least one light-diffusing reflective surface comprises a plurality of apertures and wherein beams emitted by said plurality of illumination elements pass through said apertures in said at least one light-diffusing reflective surface.

10. The illumination device as in claim 1, wherein said at least one light-diffusing reflective surface comprises an assembly of plurality of light-diffusing reflective surfaces.

11. The illumination device, as in claim 1, further comprises a light-guide element, wherein said light-guide element functions as a diffusing mirror.

12. The illumination device, as in claim 1, further comprises a light-guide element, wherein said light-guide element comprises a luminophore and a mirror, and wherein said light-guide element reflects and transforms blue light into white light.

13. The illumination device as in claim 1, wherein said exterior surface of said bulb-shaped housing comprises a reflector.

14. The illumination device as in claim 1, wherein a shape of said device is linear.

15. The illumination device, as in claim 1, further comprises a cylindrical mirror.

16. The illumination device, as in claim 1, comprises a mirror with multi-faceted surface.

17. The illumination device, as in claim 16, wherein said mirror with multi-faceted surface further comprises several kinds of luminophores.
